(19) United States
(12) Patent Application Publication
(10) Pub. No.: US 2023/0191491 A1
(43) Pub. Date: Jun. 22, 2023

(54) OBJECT MODEL SUPPORT

(71) Applicant: Hewlett-Packard Development Company, L.P., Spring, TX (US)

(72) Inventors: Jorge Diosdado Borrego, Sant Cugat del Valles (ES); David Claramunt Morera, Sant Cugat del Valles (ES); David Chanclon Fernandez, Sant Cugat del Valles (ES); Pablo Antonio Murciego Rodriguez, Sant Cugat del Valles (ES)

(21) Appl. No.: 17/996,049

(22) PCT Filed: Apr. 29, 2020
(86) PCT No.: PCT/US2020/030351

§ 371 Date: Oct. 12, 2022

(51) Int. Cl. B22F 10/47; B22F 10/85; B33Y 40/20; B33Y 50/02; B22F 10/68

(52) U.S. Cl. CPC B22F 10/47; B22F 10/85; B33Y 40/20; B33Y 50/02; B22F 10/68; B22F 10/14

(57) ABSTRACT

An additive manufacturing process comprising adding a support to an object model to create a modified object model f an object with a support to be built. The support extends from an object end coupled to the object to a distal end to be engaged with a carrier to support the object. A build model is created by arranging the modified object model within a virtual build volume with the distal end of the support at a defined location within the virtual build volume. Instructions are then provided to build a build cake corresponding to the build model, the build cake comprising the object with support and non-solidified build material.

Additive manufacturing systems can be used to manufacture three-dimensional (3D) objects. This can be achieved, for example, by forming successive layers of a build material on a build platform and selectively solidifying portions of those layers to build up a 3D object within a build cake. Objects such as product components can be built up in layers within the build cake in an additive manufacturing system in accordance with object descriptions as part of a build instruction that are interpreted and applied by a print controller.

In an example additive manufacturing process the object is separated from the build cake in a decaking operation in which the build cake is supported on a base and non-solidified build material of the build cake is removed.

Examples of the present disclosure will now be described with reference to the accompanying Figures, in which:

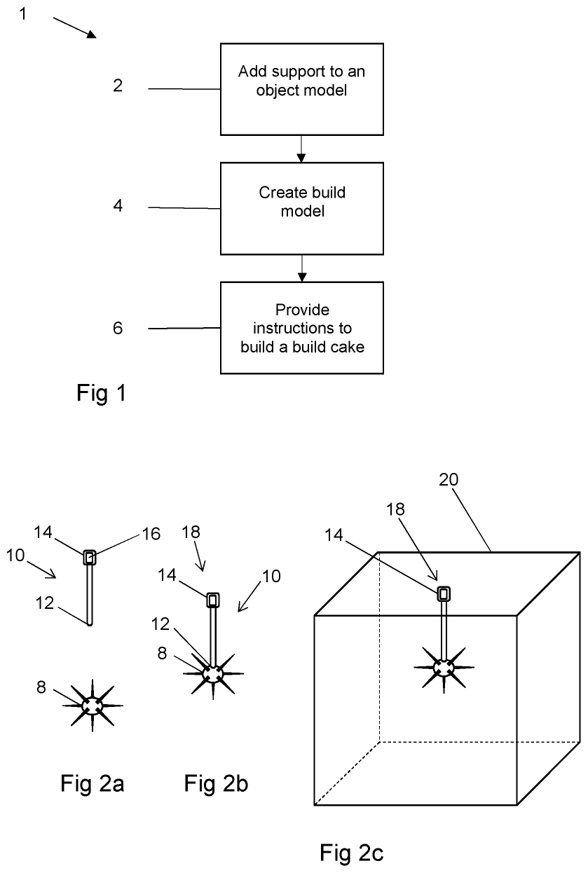

FIG. 1 shows a flowchart of an example of a process for preparing a build model for an additive manufacturing process;

FIG. 2a shows an example of an object model and a support;

FIG. 2b shows an example of a modified object model;

FIG. 2c shows an example of a modified object model arranged in a virtual build volume;

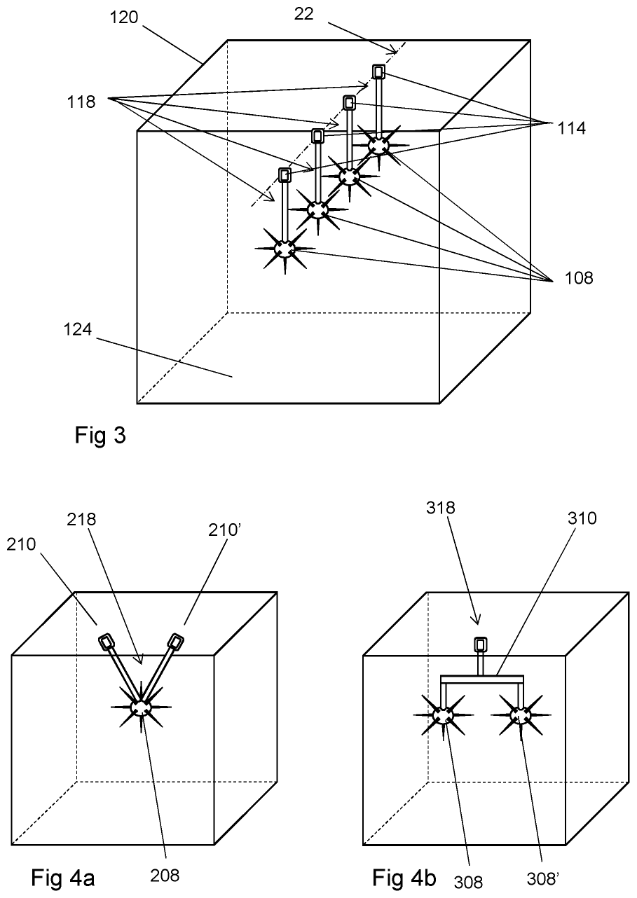

FIG. 3 shows an example of a plurality of modified object models arranged in a virtual build volume;

FIG. 4a shows an example of a modified object model comprising a single object with two supports extending therefrom;

FIG. 4b shows an example of a modified object model in which a single support is coupled to two objects;

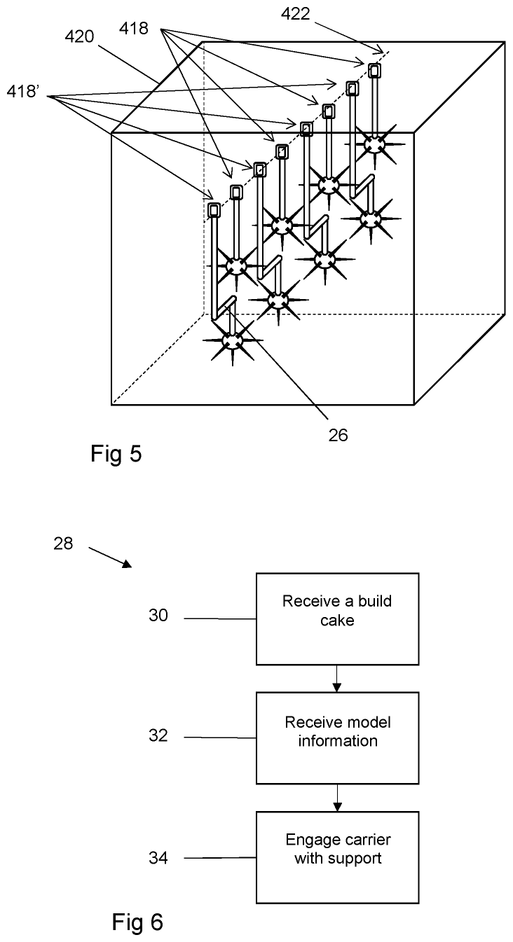

FIG. 5 shows an example of a plurality of modified object models arranged in a virtual build volume in two layers;

FIG. 6 shows a flowchart of an example method;

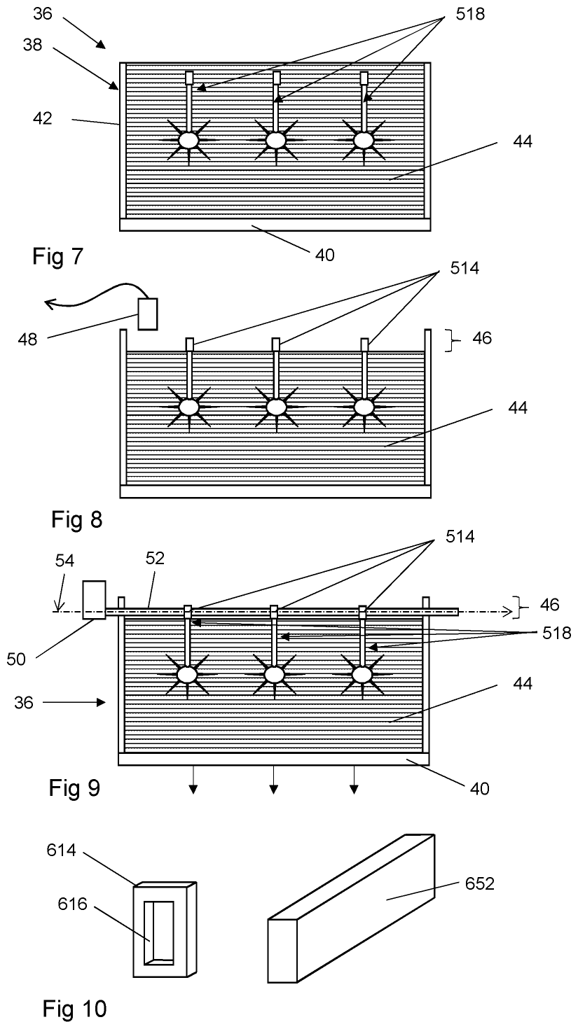

FIG. 7 shows an example of a build cake built according to a build model;

FIG. 8 shows an example of a build cake built according to a build model in which a top portion has been removed;

FIG. 9 shows an example of a build cake built according to a build model in which a top portion has been removed and in which a carrier has been engaged with the distal ends of supports;

FIG. 10 shows examples of a suspension rod and a distal end of a support;

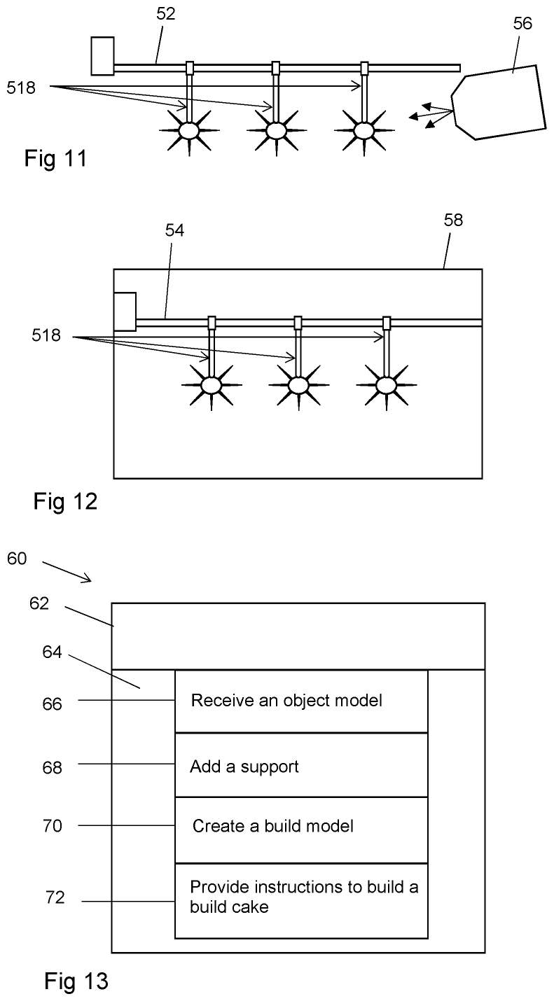

FIG. 11 shows an example of a fine decaking process;

FIG. 12 shows an example of a sintering operation; and

FIG. 13 shows an example of a controller.

FIG. 1 shows a flowchart of an example of process for preparing a build model for an additive manufacturing process 1 which comprises adding 2 a support to an object model. In this example the object model is not created as part of the process, but in other examples the process may include creating the object model. In this example the object model is a model of an object that is to be built using an additive manufacturing process.

The addition of the support to the object model creates a modified object model which is a model of an object with a support that is to be built. The support extends from an object end to a distal end. The object end of the support is coupled to the object and the distal end is to be engaged with a carrier which, in this example, is to support the object during operations that may take place after the modified object has been built. In this example the building of an object with a support based upon a modified object model may allow a carrier to interact with the object using the support, rather than by directly contacting the object itself. In some examples the object may include delicate or fragile parts which may be damaged by contact with a carrier. In this example the distal end of the support may be arranged away from the object so that the carrier to interact with the object using the support at a distance from the object.

The process 1 includes creating 4 a build model by arranging the modified object model within a virtual build volume. The modified object model is arranged with the distal end of the support at a defined location within the virtual build volume. In some examples the modified object model is arranged with the distal end of the support above the object, in some examples the distal end of the support may be arranged vertically above a centre of gravity of the object model determined as part of the process.

The addition of the support and arranging the modified object model within the virtual build volume may occur at the same time so that the design of the support and the orientation of the object within the virtual build volume can be adjusted to take account of the other object models and/or supports that are to be arranged in the virtual build volume. In some examples there may be a mixture of objects with supports and objects without supports arranged within the virtual build volume.

The process 1 further includes providing 6 instructions to build a build cake corresponding to the build model using an additive manufacturing process. A build cake built in accordance with the instructions provided comprises the object with support and non-solidified build material surrounding the object and support. The position of the distal end of the support within the build cake can be determined based on the build because the distal end of the support was arranged at a predetermined location within the virtual build volume and the build cake has been built to correspond to the build model.

The support which is added is to be used to carry, lift, or otherwise support the object during a post build operation. The addition of a support may help to prevent damage during such an operation and/or may facilitate the transport of the object to a location in which a post build operation is to be carried out. In some examples the support may be used to carry, lift, or otherwise support the object during a plurality of post build operations. Non-exhaustive examples of post-build operations include coarse decaking, fine decaking, transporting and sintering. In some examples of coarse decaking non-solidified build material is removed from around the object that has been built. In some examples of fine decaking non-solidified build material is removed from the surface of the object, for example using air jets. In some examples of sintering heat is used to sinter together metallic build material, such as powder, that was bound together using a binder during the build process. In some examples a support may be used to carry, lift, or otherwise support the object during coarse decaking, fine decaking and sintering processes.

In this example, the additive manufacturing system that is used to create the build cake uses build material which is spread over a build platform to form a build layer in a build chamber. Selected portions of the build layer may be solidified, for example by fusing, sintering, melting, binding or otherwise joining the build material using, for example, heat energy applied from an energy source and a fusing agent. The build platform is then lowered by a predetermined amount and a new build layer formed on the previously formed layer and the process repeated. In this way the build object is created within a build cake which is made up of the build object, or objects, and non-solidified build material.

The build material may comprise any suitable form of build material, for example fibres, granules or powders. The build material can include thermoplastic materials, ceramic material and metallic materials.

FIG. 2a shows an example of an object model 8 and a support 10. The support 10 comprises an object end 12 which is to be coupled to the object 8. The support 10 of this example extends linearly from the object end 12 to a distal end 14 which is for engagement with a carrier so that object 8 can be coupled to, and supported by, the carrier using the support 10.

The distal end 14 of this example includes an aperture 16 with which a carrier can engage. In other examples the distal end may include apertures of other shapes, hooks, ridges, cavities, projections, or other features with which a carrier could engage to support and carry the object using the support.

FIG. 2b shows an example of a modified object model 18 comprising an object and a support. In this example the modified object model 18 is a model of the object 8 of FIG. 2a, with the support 10 of FIG. 2a which is to be built using an additive manufacturing process. The support 10 includes an object end 12 which is coupled to the object 8. The support 10 also includes a distal end 14 that is to be engaged with a carrier to support the object during operations that may take place after the object has been built.

FIG. 2c shows an example of a modified object model, for example the modified object model 18 of FIG. 2b, arranged in a virtual build volume 20. The modified object model 18 is arranged within the virtual build volume 20 with the distal end 14 at a defined location with the virtual build volume 20. In some examples the distal end of the support is located vertically above the object end.

In these examples the object model may be created using computer aided design or other suitable methods. In some examples the object model includes delicate or fine features, such as spikes or fins. When an object is built according to the object model using an additive manufacturing process the fine or delicate features may be particularly susceptible to damage during post-build operations such as decaking or cleaning. The risk of damage may be increased if the additive manufacturing process is such that a green part is built. A green part is a part which can be subjected to a treatment after it has been built to alter its mechanical properties, for example to strengthen the part. In some examples the additive manufacturing process to be used may involve the use of a binder to selectively bind portions of a metallic build material. The part built may be considered a green part until it has been subjected to a post build operation, such as sintering, to achieve full strength. As noted above, the addition of a support to the object provides a way for a carrier to interact with the object without contacting the object itself.

In some examples addition of the supports to the object model may be automatically carried out. In some examples this automatic addition of supports occurs following a request of a user, while in other examples the addition of supports is automatic without input from a user.

To add a support to an object model the object model may be analysed to determine a coupling location of the object to which at the object end of the support can be coupled so that the object can be supported and carried using the support. In some examples a centre of gravity of the object is determined and the coupling location is selected based, at least in part, on the location of the centre of gravity. In some examples the distal end of the support, the support, the object end and the centre of gravity of the object all aligned in a single straight line.

The object model may also be analysed to determine a path for the support from the object end to the distal end that does not interfere with the object model. IN some examples the path of the support is straight as this provides the simplest and most robust support. In other examples the support may be non-linear. The support may have any suitable cross sectional shape that provides suitable structural properties. In some examples the cross sectional shape is circular or rectangular.

The object end of the support may be narrowed, waisted or otherwise weakened to facilitate removal of the support from the object after the modified object has been built. This may also reduce any damage to the object that may be caused by the removal of the support. The coupling location may be selected so that it is not readily visible in the finished object, for example on an underside of the object.

In some examples the coupling location may be selected so that it can be readily accessed in post proceeding operations to clean, polish, or otherwise treat, the coupling location once the support has been removed from the object.

In some examples the support extends in a linear manner between the object end and the distal end. In other examples the support may curve, deviate or kink between the object end and the distal end. This may allow the support to avoid other objects or parts of the object to which it is attached. In some examples the shape and design of the support may be automatically created by optimising the support, for example to minimise the volume of the support but subject to constraints such as not colliding with any other supports or object models.

The virtual build volume is a virtual space intended to represent in a virtual manner some, or all, of the build volume in which objects can be built in an additive manufacturing build device. The virtual build volume may be specific to particular additive manufacturing build device.

In some examples, once the build model has been created by arranging modified object models within the virtual build volume, the build model may be divided into a plurality of horizontal layers which represent the layers of build material created during an additive manufacturing process.

The predetermined location for the distal end within the virtual build volume may be located above the object as this means that the distal end of the support may be exposed by removing upper layers of unsolidified build material of the build cake. In other examples the predetermined location for the distal end maybe below the object, or to the side of the object. In such examples the carrier may be pushed into the, or moved through the build cake to engage with the distal end of the support.

FIG. 3 shows an example of a build model in which a plurality of modified object models 118 arranged in a virtual build volume 120. The plurality of modified object models 118 are arranged with the distal ends 114 of the supports associated with the objects 108 aligned along a first axis 22. Each support extends substantially vertically from the distal end to the object end. The first axis 22 of this example is substantially parallel with a base 124 of the virtual build volume 120 as this may facilitate engagement with a carrier as will be explained below.

In other examples a first set of modified object models may be arranged with the distal ends of the supports aligned along first axis and second, or subsequent sets of modified object models may be arranged with the distal ends of the supports aligned along second, or subsequent, axes so that all the plurality of objects can be aligned in rows to allow more efficient packing of the virtual build volume 120. In some examples all the objects having supports with a distal end aligned along one axis are at the same vertical position within the virtual build volume which may be the same at the height of objects having supports with a distal end aligned along a different axis. In other examples some of the objects having supports with a distal end aligned along one axis may be at different heights within the virtual build volume. In examples having distal ends of supports aligned along different axes the axes may be substantially parallel. In examples having distal ends of supports aligned along different axes the axes may be arranged at substantially the same height within the virtual build volume.

FIG. 4a shows an example of a modified object model 218 comprising a single object 208 with two supports 210, 210′ extending therefrom. In this example each of the two supports 210, 210′ include an object end coupled to the object 208 and a distal end for engagement with a carrier. In other examples the two supports 210,210′ may merge and share either a single object end, or a single distal end. In this example two supports are illustrated, but in other examples there may be more than two supports. Providing two supports allows a carrier to interact with the object using one, the other, or both of the supports. Interacting with the object using a plurality of supports may provide a greater degree of control over movement of the object or may allow a heavy or large object to be more readily carried, for example where a single support having appropriate structural properties is not possible due to constraints such as size or packing constraints.

FIG. 4b shows an example of a modified object model 318 in which a single support 310 coupled to two objects 308. In this example the modified object model 318 comprises two objects 308,308′ and a single support 310 which comprises a single distal end and two object ends, each coupled to one of the objects 308,308′. In other examples there may be more objects 308,308′ coupled to single support, of the single support may include a plurality of distal ends. In this example two objects are illustrated being supported by one support, but in other examples there may be more than two objects. Providing one support coupled to a plurality of objects allows a carrier to interact with a plurality of objects using one support which can facilitate automatic handling.

FIG. 5 shows an example of a plurality of modified object models 418,418′ arranged in a virtual build volume 420 in two layers, or two different vertical positions, within the virtual build volume. In this example there are two sets of modified object models 418,418′. An upper set of modified object models 418 is essentially the same as the plurality of object models 118 of FIG. 3. The lower set of modified object models 418′ is similar except that the support extends a greater distance from the distal end to the object end. In this example the supports of the lower set of modified object models 418′ include a kink 26 to allow the objects of the lower set of modified object models 418′ to be vertically offset from the distal end of the supports so that they can be arranged below the objects of the upper set of modified object models 418 while the distal ends can be arranged so that they are spaced along a first axis 422. In other examples there may be more than two sets of objects arranged at different vertical positions within the virtual build volume 420.

The positioning of objects in different vertical positions within the virtual build volume can be combined with the use of a second, or subsequent, axes along which the distal ends are arranged to facilitate the efficient packing of objects within the virtual build volume. In some examples the second, or subsequent axes, are not parallel with the first axis.

FIG. 6 shows a flowchart of an example method 28 in which a build cake is received 30. In this example the build cake is built to correspond to a build model and comprising an object with a support as described above. The support extends from an object end coupled to the object to a distal end. As noted above the build model may correspond with all of, or a portion of, the build cake created in an additive manufacturing process. In examples in which the build model corresponds with a portion of the build cake the location of that portion within the build cake is determined as part of the creation of the build model so that the location of the distal end of the support within the build cake is known based upon the predetermined location within the virtual build volume.

In other examples the build cake may comprise an object with an integral support. The integral support is not a support added to the object, but a feature of the object with which includes a distal end with which a carrier can engage to support or carry the object. An object may include a plurality of integral supports. A build cake may be built to correspond to a build model which includes an object with an integral support in which the distal end is arranged at a predetermined location.

In some examples a build cake may be built which comprises an object with an integral support and an object to which a support has been added.

The method comprises receiving 32 model information relating to the build model. The model information includes information relating to the location of the distal end of the support within the build cake. The model information may also include information about the location of the build model within the build cake as discussed above.

Based on the model information a carrier is engaged 34 with the distal end of the support. The engagement of the carrier with the distal end of the support may be an automatic process controlled by a controller that carries out the method set out above. In some examples the engagement of a carrier with the distal ends may be a manual process, or partially automated process.

Engaging the carrier with the distal end of the support may take place after the distal end has been exposed by a partial decaking operation in which non-solidified build material of a top portion of the build cake is removed. This facilitates engagement of the carrier with the distal ends. In other examples the carrier may be moved through the non-solidified build material to engage the distal end of the support.

In some examples the carrier may be an elongate rod which may be moved along a road axis to engage with the distal end. A leading tip of the rod may be sharpened or pointed to facilitate movement through the non-solidified build material.

In examples in which the carrier is moved through the non-solidified build material to engage the distal end of the support guides may be provided so that a user can align the carrier with the distal end so that when the carrier is inserted into the non-solidified material and moved through the build cake it engages the distal end. In such examples the distal end may be aligned on a predetermined axis which substantially corresponds with the guides.

FIG. 7 shows an example of a build cake 36 built according to a build model. The build cake 36 is held within a container 38. The container 38 includes a base 40 to support the build cake 36 and side walls 42 to enclose the build cake 36. The build cake 36 comprises a plurality of modified objects 518 surrounded by non-solidified build material 44. The container 36 may be a build chamber in which the build cake was build, or may be a container such as a transfer box, into which the build cake was transferred after it was build

FIG. 8 shows an example of the build cake 36 built according to a build model in which a top portion 46 has been removed. The top portion 46 of the build cake 36 that has been removed comprises a plurality of layers of non-solidified material 44. The removal of the layers of non-solidified material 44 exposes the distal ends 514 of the supports. The non-solidified build material 44 is removed in this example by a movable vacuum nozzle 48 which can remove the non-solidified build material without contacting the distal ends of the supports, but other removal methods could be employed such as vibration.

FIG. 9 shows an example of the build cake of FIG. 7 built according to a build model in which a top portion 46 has been removed and in which a carrier 50 has been engaged with the distal ends 514 of supports.

The carrier 50 comprises a suspension rod 52 which extends along a rod axis 54. In this example the distal ends 514 are aligned along a first axis and, prior to the suspension rod 52 being engaged with the distal ends 514, the rod axis 54 is aligned with the first axis and the suspension rod 52 is then advanced along the rod axis 54 to sequentially engage with the distal ends 514 of the modified objects.

In this example the side walls 42 include slots, or other openings, through which the suspension rod can pass. In other examples the carrier may include a plurality of hooks or other engagement ends which can be moved into engagement with the distal ends without passing through the side walls 42. In yet further examples a plurality of carriers may be employed, each engaging a subset of the distal ends.

With the distal ends 514 engaged with the suspension rod 52 the suspension rod 52 can be used to carry, or suspend the modified objects 518 which allows a coarse decaking operation to be carried out in which non-solidified build material 44 is removed from the build cake 36. In this example the non-solidified build material 44 is removed from the build cake 36 through apertures in the base 40, but in other example the non-solidified build material 44 can be removed from the build cake 36 in other ways such as using a suction device.

FIG. 10 shows examples of a distal end 614 of a support and a suspension rod 652. In these examples the distal end 614 comprises an opening 616 therethrough the cross section shape of which is substantially constant along its length and which substantially matches the cross sectional shape of the suspension rod 652. Since the cross section shape of the opening 616 is not circular the engagement of the suspension rod 652 within the opening 616 of the distal end 614 prevents the distal end 614 rotating relative to the suspension rod 652. This helps to control swinging of the modified object swinging from the suspension rod. Other combinations of distal end shape and suspension rod, or carrier, shape can be employed to control swinging or undesired movement of the modified object when it is carried by the carrier. This may reduce the risk of damage to the objects by preventing the objects moving in an uncontrolled way and contacting each other when being carried by the carrier.

FIG. 11 shows an example of a fine decaking process. This example shows the modified objects 518 suspended from the suspension rod 52 of FIG. 9 after the non-solidified material has been removed from around the modified objects 518.

A jet nozzle 56 is used to blow a high velocity air stream at the modified objects to remove any non-solidified material that may remain on the modified objects. The jet stream can cause objects to swing or move in an uncontrolled manner if the engagement between the distal end and the suspension rod 52, or carrier, does not prevent, or inhibit such movement.

FIG. 12 shows an example of a sintering operation. This example shows the modified objects 518 suspended from the suspension rod 54 of FIG. 9 after the non-solidified material has been removed from around the modified objects 518. The suspension rod 54 and modified objects 518 suspended therefrom are located inside a sintering oven 58. This is one example of a possible post-build operation that can be carried out while the objects are coupled to a carrier by the supports.

FIG. 13 shows a schematic diagram of a controller 60. The controller 60 may be suitable for use as the controller in an additive manufacturing system. In this example the controller 60 comprises a non-transitory computer-readable storage medium 62 comprising instructions 64 executable by a processor. The computer-readable storage medium 62 comprising:

Instructions 66 to receive an object model.

Instructions 68 to add a support to the object model.

Instructions 70 to create a build model.

Instructions 72 to provide instructions to build a build cake that corresponds to the build model.

1. A process to prepare a build model:
adding a support to an object model to create a modified object model of an object with a support to be built, the support extending from an object end coupled to the object to a distal end to be engaged with a carrier to support the object;
creating a build model by arranging the modified object model within a virtual build volume with the distal end of the support at a defined location within the virtual build volume;
providing instructions to build a build cake using an additive manufacturing process corresponding to the build model, the build cake comprising the object with support and non-solidified build material.

2. A process as claimed in claim 1, in which the support is added to the object model automatically.

3. A process as claimed in claim 1, in which the modified object model is arranged within the virtual build volume automatically.

4. A process as claimed in claim 1, in which the support is a hanger from which the object can be suspended when engaged with the carrier.

5. A process as claimed in claim 4, in which the distal end of the hanger comprises a coupling to engage with the carrier to restrict swinging of the object when suspended therefrom.

6. A process as claimed in claim 1, in which the support comprises a further object end which is coupled to a further object model so that the modified object model comprises a support coupled to an object at an object end and to a further object at a further object end.

7. A method comprising;
receiving a build cake, the build cake built to correspond to a build model and comprising an object with a support the support extending from an object end coupled to the object to a distal end;
receiving model information about the build model, the model information including information relating to the location of the distal end of the support within the build cake; and
based on the model information, automatically engaging a carrier with a distal end of a support to support the object during a subsequent operation.

8. A method as claimed in claim 7, in which the defined location of the distal end of the support within the virtual build volume is above the object and the method comprises removing an upper layer of non-solidified build material from the build cake to expose the distal end of the support prior to engaging the distal end with the carrier.

9. A process as claimed in claim 7, in which the build cake comprises a plurality of objects, each object including a support extending from an object end coupled to the object to a distal end, and the model information about the build model includes information relating to the location of each of the distal ends of the supports within the build cake; and
engaging a carrier with the distal ends of a set of the supports to support a plurality of objects during a subsequent operation.

10. A process as claimed in claim 9, in which the carrier comprises a suspension rod which extends along a rod axis, and in which the suspension rod is sequentially engaged with the end portions of a set of supports by moving the suspension rod along the rod axis.

11. A process as claimed in claim 10, in which the carrier supports the object during a decaking operation.

12. A process as claimed in claim 10, in which the carrier moves the object to a sintering location and supports the object during a sintering operation.

13. An additive manufacturing controller to:
receive an object model of an object to be built;
automatically add a support to the object model to create a modified object model of an object with support to be built, the support extending from an object end to a distal end, the object end being coupled to the object;
automatically create a build model by arranging the object model within a virtual build volume with the distal end of the support at a defined location within the virtual build volume; and
provide instructions to build a build cake corresponding to the build model, the build cake comprising the object with support and non-solidified build material.

14. A controller as claimed in claim 13, in which the controller is to:
receive a plurality of object models of objects to be built;
automatically add a support to each of the object models to create a plurality of modified object models, each modified object model being of an object with support to be built, each support extending from an object end to a distal end, the object end being coupled to an object;
automatically create a build model by arranging the plurality of modified object models within a virtual build volume with the distal ends of the supports at defined locations, and in defined orientations, within the virtual build volume;
provide instructions to build a build cake corresponding to the virtual build volume, the build cake comprising the plurality of objects with supports and non-solidified build material.

15. A controller as claimed in claim 14, in which the distal ends of each support includes a coupling to engage with a carrier comprising a suspension rod, the suspension rod extending along a rod axis, and the couplings of a set of supports are arranged within the virtual build volume so that they can be sequentially engaged by a suspension rod moving along the rod axis.
